(19) United States
(12) Patent Application Publication
(10) Pub. No.: US 2007/0271109 A1
(43) Pub. Date: Nov. 22, 2007

(54) Method and system for providing job listing monitoring

(75) Inventors: Liu Wang, Sunnyvale, CA (US); Abhishek Shrivastava, Sunnyvale, CA (US); Chyr-Chong (Joseph) Ting, San Jose, CA (US)

Correspondence Address: GREENBERG TRAURIG, LLP, MET LIFE BUILDING, 200 PARK AVENUE, NEW YORK, NY, 10166, US

(73) Assignee: YAHOO! INC., Sunnyvale, CA (US)

(21) Appl. No.: 11/437,046

(22) Filed: May 19, 2006

(51) Int. Cl. G06Q 10/00; G06Q 30/00

(52) U.S. Cl. 705/1

(57) ABSTRACT

A method and system of providing monitoring of a job listing is disclosed. A request to post a job listing is received from a recruiter. An indication of interest in employment for a job represented by the job listing is received form a jobseeker. A determination is made as to whether the job listing is being monitored. The jobseeker information is placed in a monitored folder if the job listing is determined to be monitored. The monitored folder is a data folder that is accessible to the recruiter. Furthermore, the jobseeker information is placed in a non-monitored folder if the job is not to be monitored.

### BACKGROUND

1. Field

This disclosure relates to systems and methods for monitoring job listings. In particular, the disclosure relates to systems and methods for monitoring and tracking recruiter and jobseeker activity as related to job listings and hiring practices.

2. General Background

Various job search engines are available to jobseekers that enable the jobseeker to search, view, and apply for jobs offered on the World Wide Web and other information sharing infrastructures. In addition, job search engines continue to become more popular among jobseekers and recruiters. With extensive usage of the World Wide Web as a medium for job searching and recruiting, there is an increased need to efficiently monitor recruiter and jobseeker activity to ensure employer or recruiter compliance with regulatory requirements. In addition, government regulations have recently required recruiters to track information regarding minority jobseekers.

### SUMMARY

In one aspect of this disclosure, there is a method of providing monitoring of a job listing is described in this method. A request to post a job listing is received from a recruiter. An indication of interest in employment for a job represented by the job listing is received from a jobseeker. A determination is made as to whether the job listing is being monitored. The jobseeker information is placed in a monitored folder if the job listing is determined to be monitored. The monitored folder is a data folder that is accessible to the recruiter. Furthermore, the jobseeker information is placed in a non-monitored folder if the job is not to be monitored.

In a further aspect of the method, the job listing is determined to be monitored if the request comprises an indication of whether the job listing is to be monitored. Alternatively, the job listing is determined to be monitored if the recruiter has previously opted to have all of the job listings that the recruiter posts monitored.

In another aspect, a recruiter's attempt to remove the job listing from the monitored folder is blocked.

In an additional aspect of the method, a snapshot of a resume submitted by the jobseeker is taken. Alternatively, a job listing snapshot of the job listing applied for by the jobseeker can be taken.

In yet a further aspect, a request to perform an action related to the job listing can be received from a recruiter. The action can be editing the job listing, deleting the job listing, etc. Further, if it is determined that the job listing is in the monitored folder, the action is recorded.

Likewise, in a further aspect, a request to perform a search related to the job listing can be received from a recruiter. If it is determined that the job listing is in the monitored folder, the search request can be recorded.

In another aspect, there is a system of monitoring a job listing comprising a recruiter service module and a jobseeker service module. The recruiter service module receives a request to post a job listing from a recruiter. The jobseeker service module receives an indication from a jobseeker that the jobseeker is interested in the job represented by the job listing. The jobseeker service module places the jobseeker information in a monitored folder if the jobseeker service module determines that the job is to be monitored. In addition, the system can also comprise a monitoring module that records an action request received from the recruiter.

### DRAWINGS

By way of example, reference will now be made to the accompanying drawings.

FIGS. 1A-1B illustrate a system for monitoring job listing activity.

FIG. 2 illustrates a block diagram of a recruiter service module.

FIG. 3 illustrates a flow diagram of a process of monitoring job listing activity.

FIG. 4 illustrates a flow diagram of a process of posting a job listing.

FIG. 5 illustrates a screen shot of a job manager user interface.

FIG. 6 illustrates a flow diagram of a process of permitting a jobseeker to apply for a job.

FIG. 7 illustrates a screen shot of a candidate manager interface showing a list of jobseekers in a monitored application folder.

FIG. 8 illustrates a screen shot of a candidate manager interface.

FIG. 9 illustrates a flow diagram of a process of providing candidate management.

FIG. 10 illustrates a flow diagram of a process of providing a jobseeker search.

### DETAILED DESCRIPTION

The methods and systems described herein permit a recruiter that posts job listings on the World Wide Web to monitor recruiting activities related to the jobs that the recruiter has posted, as well as activities of jobseekers who apply for the jobs posted by the recruiter. In one embodiment, the monitoring of activity related to job listings encompasses the monitoring criteria as delineated by federal requirements. In particular, executive orders and federal legislation currently require government contractors to provide equal employment opportunities to all individuals, regardless of race, religion, national origin, sex, age, disability or veteran status. The Office of Federal Contract Compliance Programs (OFCCP) of the Department of Labor has defined the term “Internet applicant” for the purposes of such regulations. As such, certain federal government contractors must monitor and track the gender, race and ethnic backgrounds of Internet jobseekers, keep a copy of submitted resumes, and analyze whether hiring policies have had an “adverse impact” on any predetermined class as delineated above.

The systems and methods disclosed herein permit a recruiter to opt in to be a monitored recruiter. If the recruiter opts in to be monitored, all of the actions, searches, and postings submitted by the recruiter will be treated as monitored and can be recorded and kept for further analysis. In another embodiment, the recruiter can mark job listings that fall under the federal regulations requirements for monitoring.

In order to monitor specific jobseeker and recruiter actions, one embodiment of the system includes taking snapshots of candidate resumes, application materials, recruiter search queries, etc. Actions that trigger snapshots can include a jobseeker application, copying a candidate to a data folder, distributing jobseeker information, sending a letter to a jobseeker, flagging a jobseeker as a candidate, issuing a search request, etc.

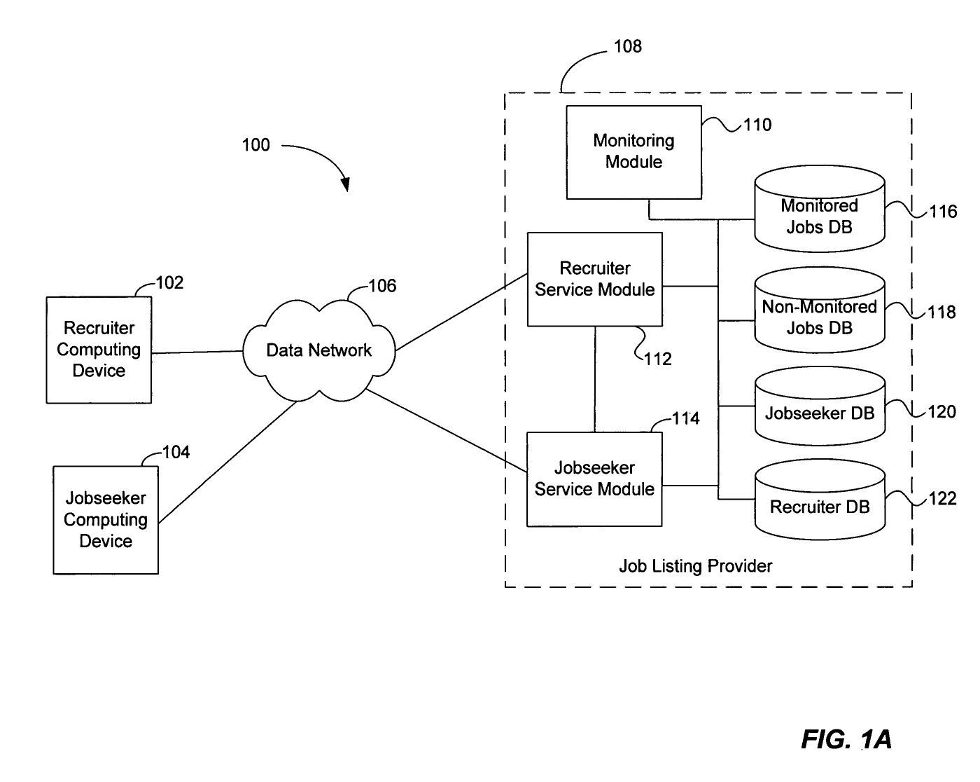

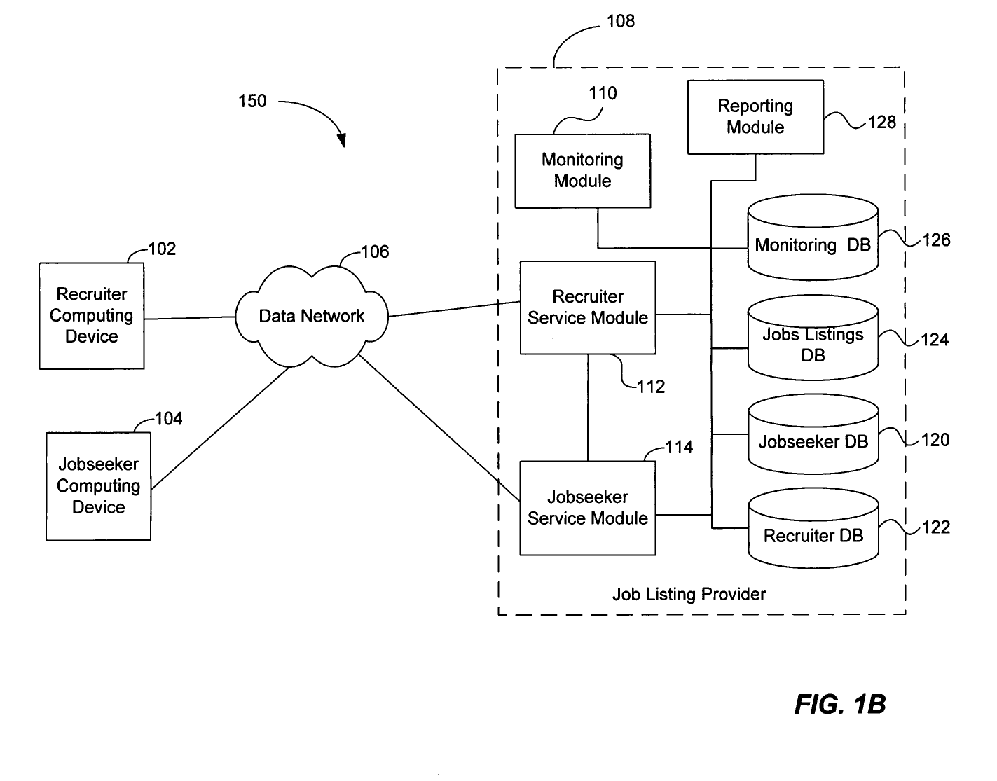

FIG. 1A illustrates a system 100 for monitoring job listing activity. This exemplary system can include a recruiting service module 112 that is accessible to a recruiter through a recruiter computing device 102. The recruiter computing device 102 and the recruiting service module 112 communicates and exchanges data through a data network 106. In one embodiment, the data network 106 is the Internet. In another embodiment, the data network 106 is an intranet. The recruiter service module 112 can be configured with logic (e.g. computer software) to receive recruiters' actions and requests related to job listings. For example, recruiters can make requests via recruiter service module 112 such as to add a new job listing, delete a job listing, or edit a job listing. In addition, the recruiter service module 112 can interact with a monitoring module 110 which is configured with logic to determine jobseeker and recruiter activity and to monitor such activity. The recruiter service module 112 can also be configured to access various data repositories in order to perform the operations requested by the recruiter. The recruiter service module 112 can further connect with the monitored jobs database 116 to store and retrieve job listings that have been designated to be monitored. The recruiter service module 112 can also connect with the non-monitored jobs database 118 to store and retrieve job listings that have not been designated to be monitored.

The recruiter service module 112 can further access data repositories containing jobseeker profiles as well as recruiter profiles. In one example, the recruiter service module 112 accesses the jobseeker database 120 to retrieve candidates for a job listing. The recruiter service module 112 can also connect with the recruiter database 122 to store and retrieve recruiters' profiles, preferences, job listing associations, etc.

Furthermore, a jobseeker can view the job listings posted at a job listing provider 108 by connecting with a jobseeker service module 114. In order to connect with the jobseeker service module 114, the jobseeker can utilize a jobseeker computing device 104 that communicates with the jobseeker service module 114 through the data network 106. The jobseeker service module 114 can be configured to receive job listing requests from the jobseeker computing device 104 such as a search request, application for a job, request for information related to a job listing, submission of user preferences, user personal data, etc. As such, the jobseeker service module 114 can communicate with the jobseeker database 120 to store jobseeker profiles. In one example, the jobseeker database 120 can contain user profiles that include age, race and gender of the jobseeker.

As previously mentioned, the monitoring module 110 can be configured to track, monitor, record, and analyze data as required by the job listing provider 108 or by the recruiter. Through the recruiter service module 112, the recruiter can mark each job listing to indicate whether the job listing is to be monitored. Recruiter and jobseeker activity can be collected and recorded in one or more data repositories, such as the monitored jobs database, the non-monitored jobs database 118, or a separate monitoring database wherein recruiter and jobseeker activity can be stored. Recruiter activity can, for example, include jobs posted, minimum application requirements, job listings removed, candidates searched, candidates selected, candidates declined, candidates hired, job listing version, recruiter identifier, etc. Jobseeker activity can include resumes and submitted application materials, application data, qualifications, profiles, jobs applied for, application dates, candidate notes, etc.

FIG. 1B illustrates an exemplary system 150 for monitoring as in system 100 with the added functionality of reporting job listing activity. A monitoring database 126 can be implemented so as to include records for all of the activity that is being monitored, tracked and recorded. Also, a job listings database 124 that includes monitored and non-monitored job listings can be utilized instead of a separate database for monitored job listings and non-monitored job listings. The job listings in the job listings database are marked in each job listing record as being monitored or non-monitored. Additionally, a reporting module 128 can be provided to create reports listing jobseeker and recruiter activity such as jobs posted, minimum application requirements, job listings removed, candidates selected, candidates declined, etc.

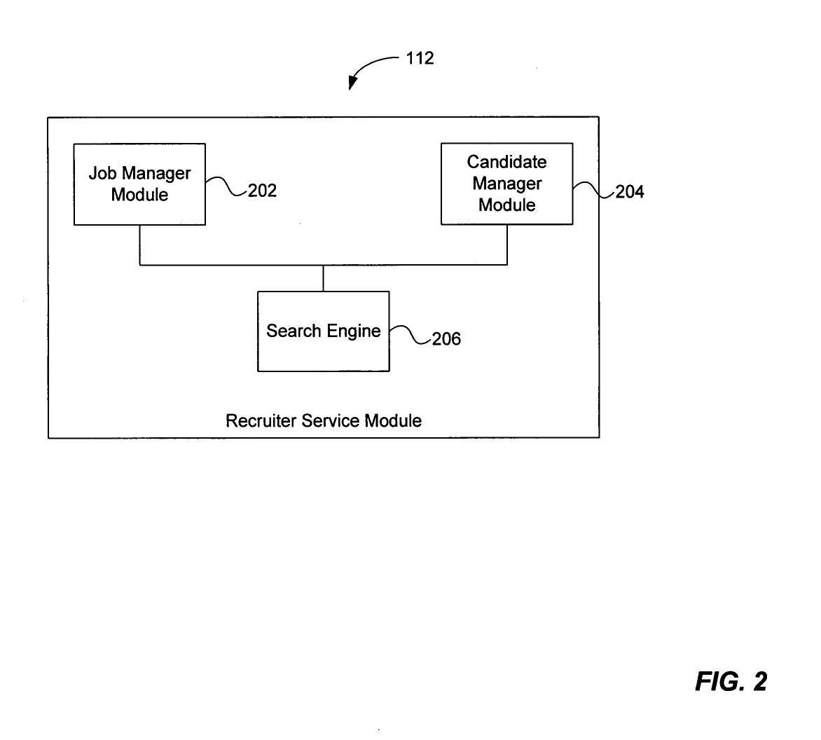

FIG. 2 illustrates a block diagram of an exemplary recruiter service module 112. In one embodiment, the recruiter service module 112 can comprise a job manager module 202, a candidate manager module 204, and a search engine 206. The job manager module 202 can be configured to interact with the recruiter by receiving recruiter instructions for managing job listings. For example, the job manager module 202 can be configured with logic to allow a recruiter to post, add, or delete a job listing. In another example, the job manager module 202 can be configured with logic to allow a recruiter to flag or mark a job listing as being a monitored job listing. The job manager module 202 can also be configured with logic to make an association between a job listing and candidates that have applied for that job listing. In addition, the job manager module 202 can also be configured with logic to make an association between a job listing and candidates that the recruiter believes to be a good match for a specific job listing. In another example, the job manager module 202 can also be configured with logic to copy a job listing to a folder, or to move a job listing from one folder to another folder. In one embodiment, all of the activities that a recruiter performs as related to a job listing that is marked to be monitored can be tracked and monitored by the monitoring module 110. In another embodiment, all of the activities that a recruiter has performed as related to a job listing can be marked to be monitored if the recruiter has indicated that the recruiter wants to be marked as a monitored recruiter.

Furthermore, the candidate manager module 204 can allow a recruiter to manage jobseekers who have expressed an interest in a job listing or that the recruiter would like to consider for a specific job. Thus, the candidate manager module 204 can be configured with logic to allow a recruiter to mark, contact, or remove a candidate from consideration, add a candidate to a job listing folder, remove a candidate from a job listing folder, view candidates who applied for monitored jobs, view candidates who have applied for a specific job, etc.

In one embodiment, all of the activities that a recruiter performs as related to a candidate that is marked to be monitored can be tracked and monitored by the monitoring module 110. In another embodiment, all of the activities that a recruiter has performed as related to a candidate can be marked to be monitored if the recruiter has indicated that the recruiter wants to be marked as a monitored recruiter.

Finally, the search engine 206 can be utilized by a recruiter to submit candidate searches utilizing specified criteria. In one embodiment, the specified criteria submitted by the recruiter can be compared with the jobseeker profiles to find the best matches. The search engine 206 can perform candidate searches based on jobseeker location, skill set, etc. In another example, the search engine 206 can perform candidate searches based on years of experience. Furthermore, all of the activities that a recruiter performs as related to a search request for a candidate can be tracked and monitored by the monitoring module 110.

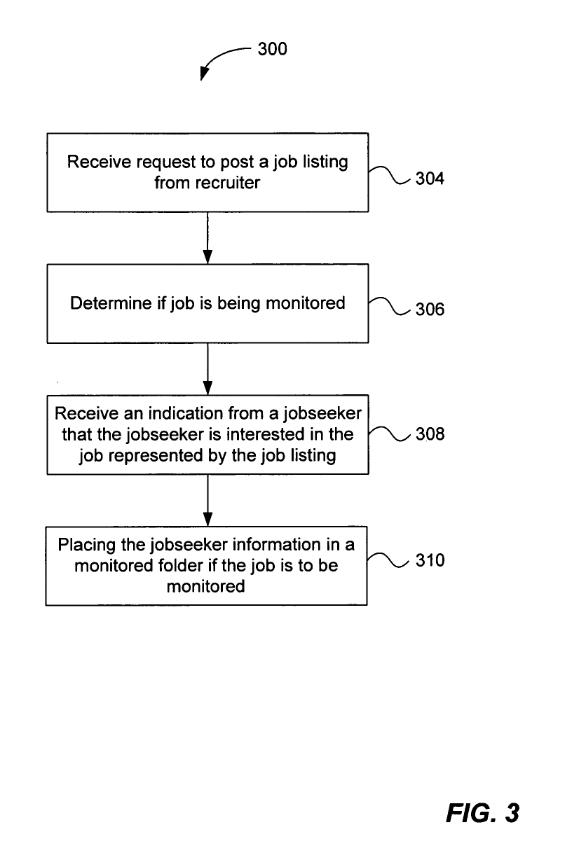

FIG. 3 illustrates a flow diagram of a process 300 of monitoring job listing activity. At process block 304, a request to post a job listing is received from a recruiter. The request can be received at the recruiter service module 112. For example, a recruiter can submit a job title, description, location and salary information. The process 300 continues to process block 306.

At process block 306, a determination is made if the job listing is to be monitored. The determination can be made utilizing one or more methods. For example, the recruiter can be inquired as to whether the job listing is to be monitored. In another example, the recruiter can indicate that as a default, any jobs posted by the recruiter must be monitored. Thus, the job listing posted by that recruiter can be automatically marked as being monitored. The process 300 continues to process block 308.

At process block 308, an indication is received from a jobseeker that the jobseeker is interested in the job represented by the job listing. The jobseeker can provide such indication by submitting a request through the jobseeker computing device 104 to the jobseeker service module 114. The process 300 continues to process block 310.

At process block 310, the jobseeker information is placed in a monitored folder if the job is to be monitored. For example, the monitored folder can be a file, or any other digital data repository, that can contain one or more records corresponding to jobseekers. Thus, the monitored folder can be stored in the monitored jobs database 116.

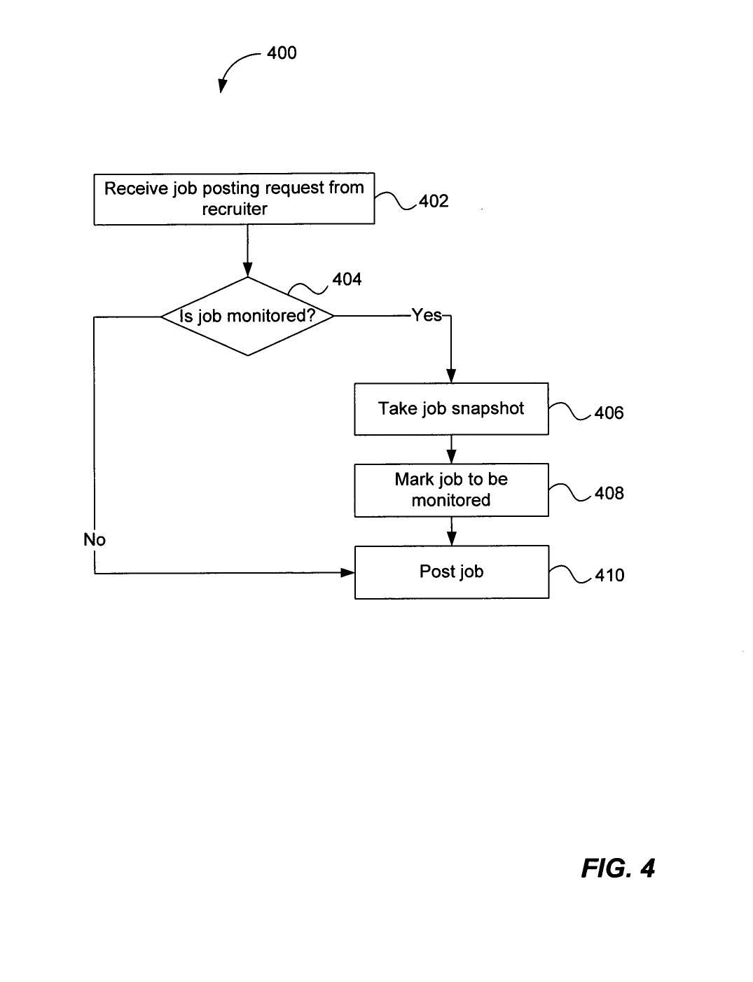

FIG. 4 illustrates a flow diagram of a process 400 of posting a job listing. At process block 402, a request to post a job listing is received from a recruiter. As previously discussed, the posting request can be received at a recruiter service module 112. The process 400 continues to decision block 404.

At decision block 404, it is determined whether the job listing is to be monitored. The job listing being posted by the recruiter can be determined to be monitored utilizing one or more methods. For example, the recruiter can be inquired as to whether the job listing is to be monitored. In another example, if the recruiter has indicated that by default all jobs posted by the recruiter are to be monitored, then the job listing being posted can be marked as being monitored. If the job listing is determined to be monitored, the process 400 continues to process block 406. If the job listing is determined not to be monitored, the process 400 continues to process block 410.

At process block 406, a snapshot of the job listing is taken. The snapshot of the job can be a record in the monitored jobs database 116. For example, a version of the job listing can be saved as a record including all of the job listing criteria such as job description, title, location, etc. The process 400 continues to process block 408.

At process block 408, the job listing is marked as being monitored. In one embodiment, storing the job in the monitored jobs database 116 can serve as marking the job listing as being monitored. Thus, the job listing can be stored in the monitored jobs database 116. In another embodiment, the job listing can be stored in a general database, and be marked to indicate that the job is a monitored job. The process 400 continues to process block 410. At process block 410, the job listing is posted.

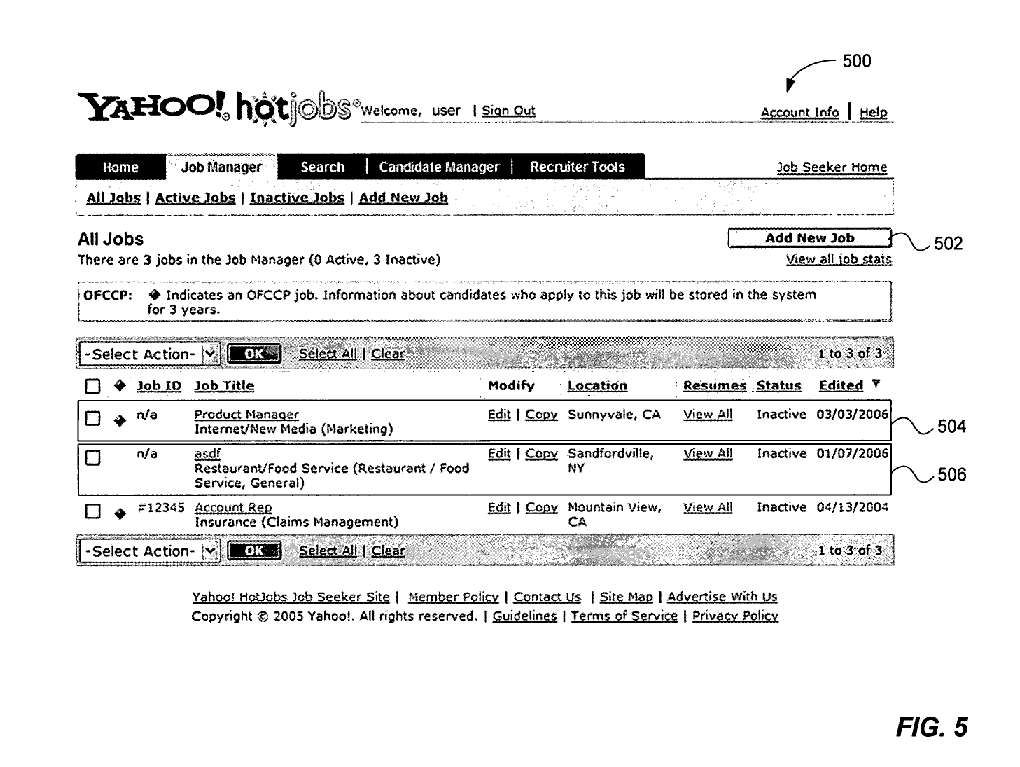

FIG. 5 illustrates a screen shot of a job manager user interface 500. In one embodiment, the job manager interface 500 is presented to the recruiter as a web page. The job manager user interface can be a user interface that the recruiter utilizes to interact with the recruiter service module 112. The user interface can be provided for display at the recruiter computing device 102 such that a recruiter can manage job listings listed by the recruiter. In one example, the recruiter accesses the job manager interface 500 after being authenticated by the recruiter service module 112. The job manager user interface 500 can provide one or more operations that are available to the recruiter to manage the job listings. For example, a recruiter can add a new job by selecting the add new job button 502.

Furthermore, the recruiter can select a job listing 504 in order to carry out an operation. Because the job listing 504 is being monitored, any of the actions performed by the recruiter are monitored and recorded by the monitoring module 110. The actions can be recorded in association with each recruiter. For example, a recruiter profile can include data representative of all of the actions performed by the recruiter. In another example, the recruiter actions can be recorded in association with each job listing. For example, a job listing record in the monitored jobs database 116 can include recruiter actions performed for that job. Recruiter actions can include creating, copying, deleting, distributing, assigning, or expiring a job listing, flagging or unflagging a candidate, etc.

The recruiter can also select a job listing 506 which is a non-monitored job. In one embodiment, the indication of whether the job listing 506 is a monitored job can be provided in the user interface. For example, job listing 504 includes a rhomboid shaped indicator, while job listing 506 does not include such indicator. One skilled in the art will recognize that any marker or flag can be utilized to indicate whether a job listing is monitored or non-monitored.

Other actions that the job manager interface 500 provides can include editing a job listing, copying a job listing, viewing the resumes of jobseekers who have applied for a job listing, etc.

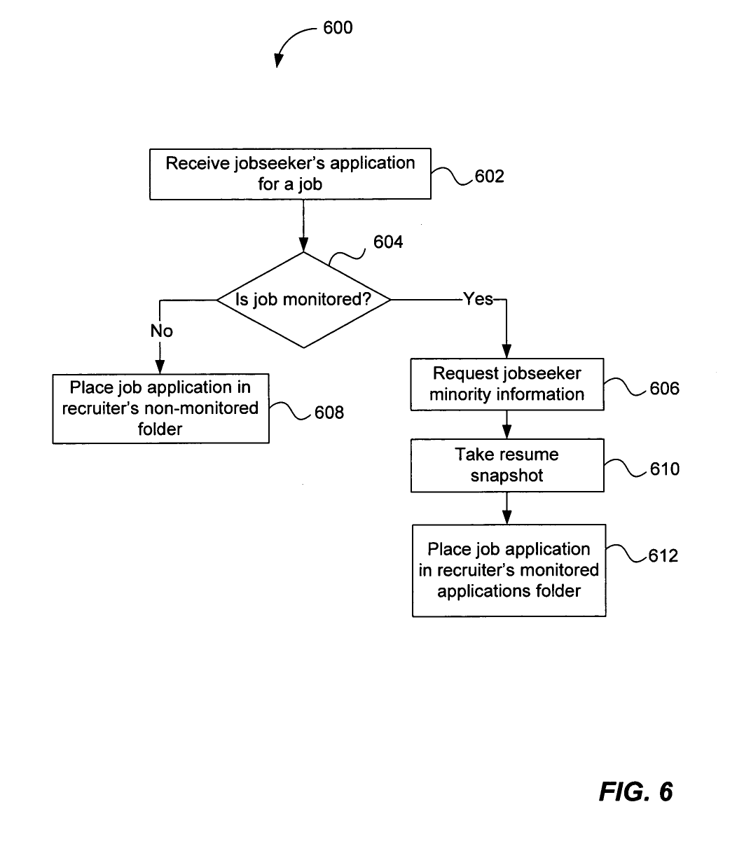

FIG. 6 illustrates a flow diagram of a process 600 of permitting a jobseeker to apply for a job. At process block 602, a jobseeker's application for a job is received. The application can be received at the jobseeker's module 114. In one embodiment, the jobseeker's module provides a user interface that is displayed at the jobseeker's computing device 104. The process 600 continues to decision block 604.

At decision block 604, it is determined whether the job listing is being monitored. The determination can be done by searching both the non-monitored jobs database 118 as well as the monitored jobs database 116. If the job listing being applied for is in the monitored jobs database 118, then the job listing is being monitored. If the job listing being applied for by the jobseeker is in the non-monitored jobs database 118, then the job listing is not being monitored. If the job listing is determined not to be monitored, the process 600 continues to process block 608. At process block 608, the job application is placed in a recruiter's non-monitored folder. In one example, the job application comprises the jobseeker's resume. In another example, the job application comprises the jobseeker's profile. Thus, if the job to which the jobseeker applied is not monitored, the recruiter can receive an entry in the non-monitored folder that indicates the jobseeker information, and the job to which the jobseeker is applying.

If the job listing is determined to be monitored, the process 600 continues to process block 606. At process block 606, the jobseeker's specific information is requested. If the jobseeker does not have an associated user profile, the jobseeker can be asked to enter personal information. In one embodiment, personal information may entail membership of the jobseeker in one or more minority groups such as ethnic minority groups or gender minority groups. In a further embodiment, an Equal Employment Opportunity Commission (EEOC) questionnaire can be presented to the jobseeker in order to collect jobseeker information. The process 600 continues to process block 610.

At process block 610, a snapshot of the jobseeker's resume can be taken. In one embodiment, the jobseeker's resume snapshot entails saving a version of the resume as a digital file having a time-stamp. Furthermore, a snapshot can also be taken of the cover letter of the jobseeker applicant. In addition, further documentation, such as writing samples, education transcripts, diplomas, certificates or any other documentation that the jobseeker submits can also be saved as a snapshot of the jobseeker's application.

The snapshot of the jobseeker's resume serves to identify the qualifications of a jobseeker and the information provided at the time of application. If, for example, the jobseeker's resume is submitted and later updated reflecting newly acquired skills, both snapshots will serve for an analysis of the hiring or non-hiring of the jobseeker. The process 600 continues to process block 612.

At process block 612, the job application is placed in a recruiter's monitored application folder. The job application stored in the folder can comprise one or more references to the jobseeker's profile, the jobseeker's resume, any other documentation submitted by the jobseeker, etc. Thus, when the recruiter accesses the monitored application folder, a list of applications and associated application materials can be accessed by the recruiter.

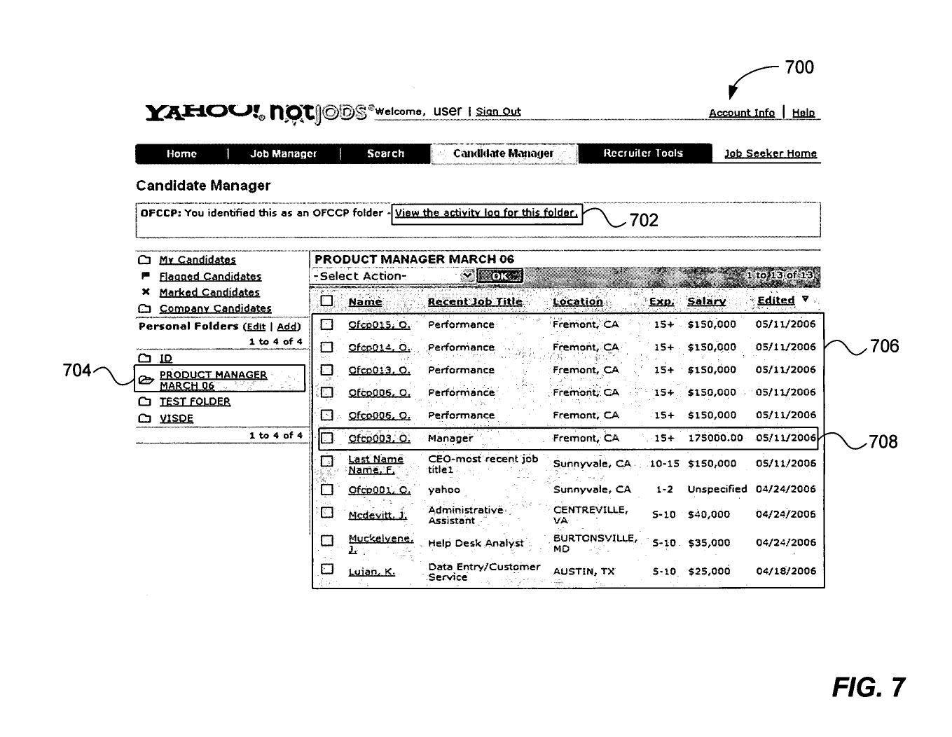

FIG. 7 illustrates an exemplary shot of a candidate manager interface 700 showing a list of jobseekers 706 in a monitored application folder 704. In one embodiment, the candidate manager interface 700 is presented to the recruiter as a web page. The list of jobseekers represent those jobseekers who have been added to the monitored application folder 704 such that any further recruiter actions related to those jobseekers are monitored, logged, and analyzed. A jobseeker can be automatically added to the monitored application folder 704 when the jobseeker applies for a monitored job. In another example, the jobseeker can be manually added to the monitored application folder 704 by a recruiter.

The monitored application folder 704 can be configured to be locked such that once an entry for a jobseeker has been added to the monitored application folder 704, the jobseeker entry cannot later be removed.

In one embodiment, the monitored application folder 704 is a folder associated with one job listing. For example, the monitored application folder 704 can be associated with a job listing for Product Manager, and the entries in the monitored application folder 704 refer to jobs that have been applied to for the Product Manager position.

In another embodiment, the monitored application folder 704 is a folder associated with a business unit. Thus, the monitored application folder 704 can be established by the recruiter in order to contain job applications from any jobseekers applying for jobs in a business unit for which the recruiter is employing. For example, the monitored application folder 704 can be for a government business unit, and any job application received for a position in that business unit can be added to the monitored application folder 704.

The monitored folder can be a data folder to which a recruiter can read and write. A data folder is any form of logical or physical partition of memory accessible to a recruiter. Thus, the data folder can be a logical drive, a plurality of data registers of a memory module, a magnetic memory drive, an optical memory disc, a text file, a file in a specific format, or any other form of data repository. In one embodiment, the monitored folder can reside in the monitoring database 126 and be accessible to the recruiter through the recruiter service module 112.

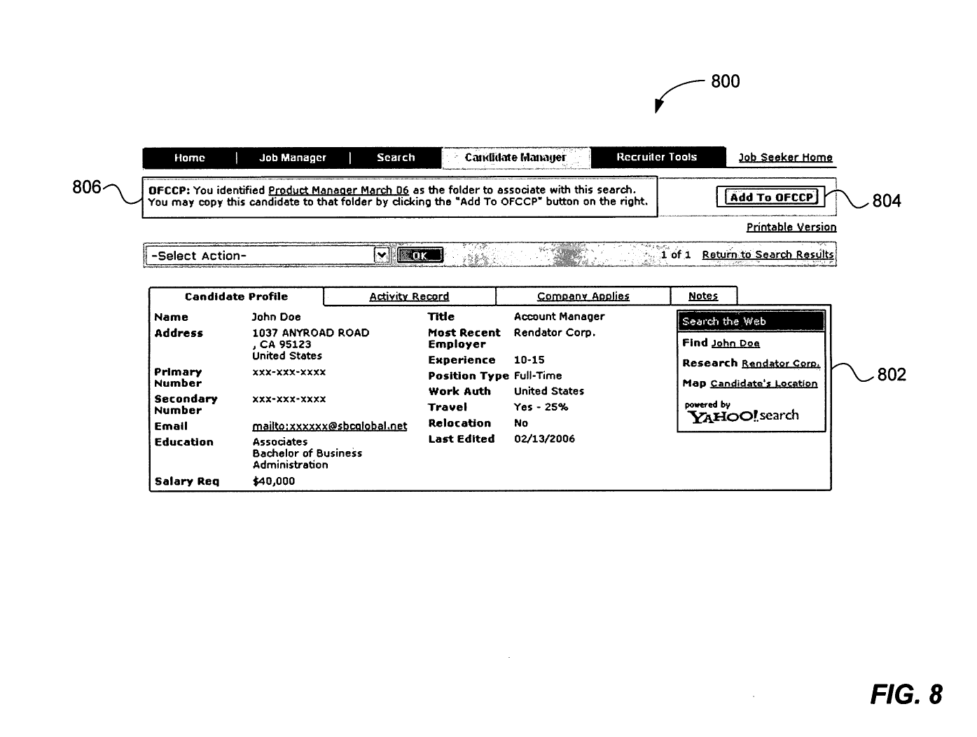

FIG. 8 illustrates an exemplary candidate profile screen shot 800 from the candidate manager interface 700. In one embodiment, once a recruiter selects a jobseeker from a list of jobseekers, such as the list of jobseekers 706, the recruiter can view the jobseeker's profile 802 by selecting a jobseeker that the recruiter is interested in. In addition, if the jobseeker selected by the recruiter is in a monitored folder, the recruiter's selection of the jobseeker can also be monitored and recorded by the monitoring module 108.

In another embodiment, the candidate manager interface can provide a jobseeker's profile 802 as part of a search result submitted by a recruiter. Thus, a recruiter's search can yield jobseeker profile 802 and be displayed for viewing by the recruiter. In addition, the recruiter can be further provided with the option of adding the jobseeker's profile 802 to a folder. For example, button 804 can be provided to add the jobseeker's profile 802 to a monitored folder. In another example, if the search is performed in relation with a specific job listing, the system can automatically add the jobseeker's profile to the folder associated with the job listing.

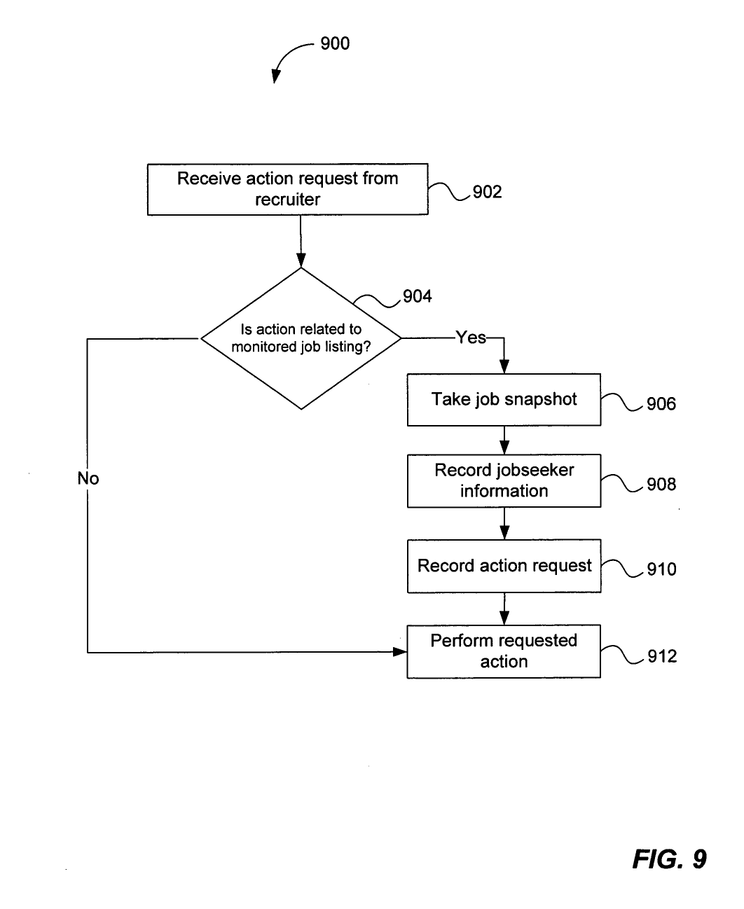

FIG. 9 illustrates a flow diagram of a process 900 of providing candidate management. At process block 902, an action request is received from a recruiter. The action request can be, for example, editing a job listing, deleting a job listing, viewing a jobseekers profile, publishing a job listing description, or copying or selecting a jobseeker's profile. The process 900 continues to decision block 904.

At decision block 904, it is determined whether the action is related to a job listing that is being monitored. The determination can be performed according to any of the methods described above. The recruiter can opt in to be a monitored recruiter. If the recruiter opts in to be monitored, all of the actions submitted by the recruiter will be treated as a monitored action. If the action is determined to be related to a job listing that is being monitored, the process 900 continues to process block 906. If the action is determined to be related to a job listing that is not being monitored, the process 900 continues to process block 912. At process block 906, a snapshot of a job is taken. The process 900 continues to process block 908.

At process block 908, the jobseeker information is recorded. This recordation of jobseeker information may include resume, profile, cover letter, or any other document related to a jobseeker. The jobseeker information can later be utilized in order to report a recruiter's actions as related to a specific jobseeker. The process 900 continues to process block 910.

At process block 910, the action requested can be recorded. In one embodiment, the recruiter's action can be stored in a recruiter's database 122. The recruiter's actions can be recorded in association with the recruiter profile. The process 900 continues to process block 912. At process block 912, the action requested by the recruiter can be performed.

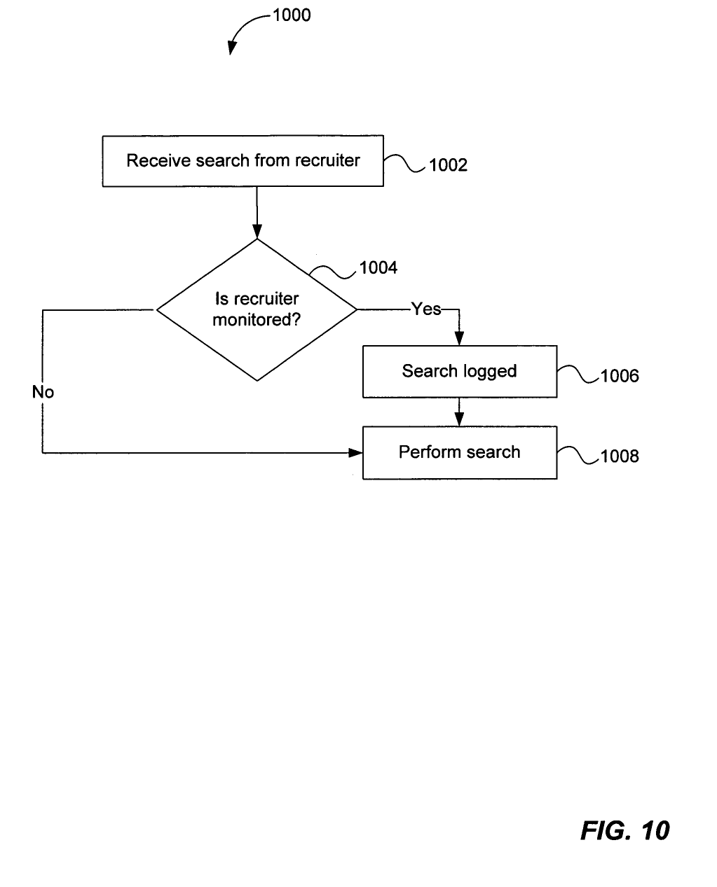

FIG. 10 illustrates a flow diagram of a process of providing a jobseeker search. At process block 1002, a search request can be received from a recruiter. The search request can be received by receiving a data query. For instance, the recruiter can submit searches according to specific definitions, such as location, industry, and skill set. In another example, the search request can be made in association with a job listing. Therefore, the recruiter can pre-establish requirements for a job listing and store the pre-established requirements in association with the job listing. Then, the recruiter can submit a search according to the pre-established requirements of the job listing. The process 1000 continues to decision block 1004.

At decision block 1004, it is determined whether the recruiter is a monitored recruiter. The recruiter can opt in to be a monitored recruiter. If the recruiter opts in to be monitored, all of the searches submitted by the recruiter will be treated as monitored searches. In another embodiment, the determination is made according to the job listing associated with the search. If the recruiter is determined not to be monitored, the process 1000 continues to process block 1008. If the recruiter is determined to be a monitored recruiter, the process 1000 continues to process block 1006.

At process block 1006, the search submitted by the recruiter is recorded. As indicated above, the search query submitted by the recruiter can be stored in one or more data repositories. For example, the query can be stored in the recruiter database 122. In another example, the query can be stored in the monitored job database 116. In yet another embodiment, the query can be stored in a search database. The process 1000 continues to process block 1008. At process block 1008, the search submitted by the recruiter is performed.

While the apparatus and method have been described in terms of what are presently considered the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A computer-implemented method of providing monitoring of a job listing, comprising:
receiving a request to post a job listing from a recruiter;
receiving from a jobseeker an indication of interest in employment for a job represented by the job listing;
determining whether the job listing is to be monitored; and
placing the jobseeker information in a monitored folder if the job listing is determined to be monitored, the monitored folder being a data folder that is accessible to the recruiter.

2. The method of claim 1, further comprising placing the jobseeker information in a non-monitored folder if the job is not monitored.

3. The method of claim 1, wherein the job listing is determined to be monitored if the request includes an indication that the job listing is to be monitored.

4. The method of claim 1, wherein the job listing is determined to be monitored if the recruiter has previously opted to have of all of the job listings that the recruiter posts monitored.

5. The method of claim 1, further comprising blocking a recruiter's attempt to remove the job listing from the monitored folder.

6. The method of claim 1, further comprising taking a resume snapshot of a resume submitted by the jobseeker.

7. The method of claim 1, further comprising taking a job listing snapshot of the job listing applied for by the jobseeker.

8. The method of claim 1, further comprising:
receiving from the recruiter a request to perform an action related to the job listing; and
recording the action request if it is determined that the job listing is in the monitored folder.

9. The method of claim 8, wherein the action requested by the recruiter is editing the job listing.

10. The method of claim 8, wherein the action requested by the recruiter is deleting the job listing.

11. The method of claim 1, further comprising:
receiving from the recruiter a request to perform a search related to the job listing; and
recording the search request if it is determined that the job listing is in the monitored folder.

12. A system of providing monitoring of a job listing, comprising:
a recruiter service module that receives a request to post a job listing from a recruiter; and
a jobseeker service module that receives an indication from a jobseeker that the jobseeker is interested in a job represented by the job listing, the jobseeker service module placing jobseeker information about the jobseeker in a monitored folder if the jobseeker service module determines that the job is to be monitored.

13. The system of claim 12, wherein the jobseeker service module places the jobseeker information in a non-monitored folder if the job is not to be monitored.

14. The system of claim 12, wherein the jobseeker service module determines that the job listing is to be monitored if the request includes an indication of whether the job listing is to be monitored.

15. The system of claim 12, wherein the jobseeker service module determines that the job listing is to be monitored if the recruiter has previously opted to have of all of the job listings that the recruiter posts monitored.

16. The system of claim 12, wherein the recruiter service module further blocks a recruiter from removing the job listing from the monitored folder.

17. The system of claim 12, further comprising a monitoring module that takes a resume snapshot of a resume submitted by the jobseeker.

18. The system of claim 12, further comprising a monitoring module that takes a job listing snapshot of the job listing in which the jobseeker expresses an interest.

19. The system of claim 12, further comprising a monitoring module that records an action request received from the recruiter.

20. The system of claim 19, wherein the action requested by the recruiter includes editing the job listing.

21. The system of claim 19, wherein the action requested by the recruiter includes deleting the job listing.

22. The system of claim 19, wherein the action requested by the recruiter includes searching the job listing.

23. The system of claim 12, further comprising a monitoring module that records a search request received from the recruiter.

24. A computer-implemented method of providing monitoring of a job listing, comprising:
receiving a request to post a job listing from a recruiter, the request being received at a recruiter service module of a job listing service computing device;
receiving from a jobseeker an indication of interest in employment for a job represented by the job listing, the indication being received at a jobseeker service module of the job listing service computing device;
determining, at the job listing service computing device, whether the job listing is being or is to be monitored; and
placing the jobseeker information in a monitored folder if the job listing is determined to be monitored, the monitored folder being a data folder that is accessible to the job listing service computing device.
